(19) United States
(12) Patent Application Publication
(10) Pub. No.: US 2003/0196685 A1
(43) Pub. Date: Oct. 23, 2003

(54) Cleaning composition and method

(75) Inventors: Edgardo Anzures, Westborough, MA (US); Robert K. Barr, Shrewsbury, MA (US); Daniel E. Lundy, Winchendon, MA (US); John P. Cahalen, Arlington, MA (US)

Correspondence Address: c/o EDWARDS & ANGELL, LLP, IP Group, Dike, Bronstein, Roberts & Cushman, P.O. Box 9169, Boston, MA, 02209, US

(73) Assignee: Shipley Company, L.L.C., Marlborough, MA

(21) Appl. No.: 10/317,967

(22) Filed: Dec. 12, 2002

Related U.S. Application Data
(60) Provisional application No. 60/341,620, filed on Dec. 18, 2001.

(51) Int. Cl. B08B 9/00; C11D 1/00

(52) U.S. Cl. 134/22.19; 510/169; 510/176

(57) ABSTRACT

A cleaning composition and method for removing built-up residue and scum on a substrate. The cleaning composition contains a compound of formula:

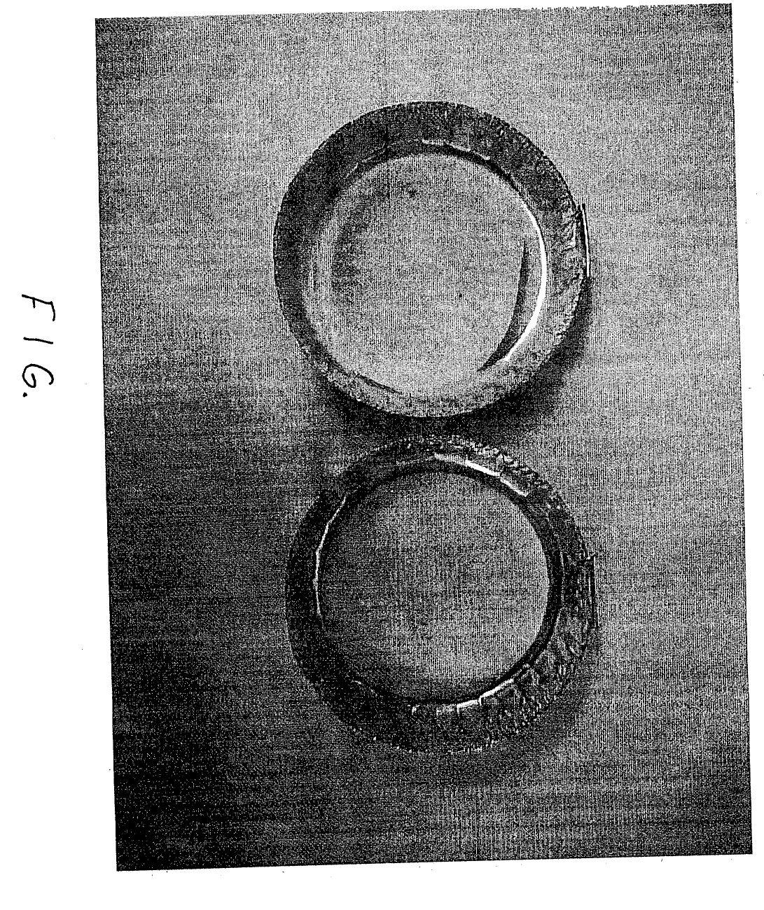

R—[O-(AO)ₙ]ₘ—Z

where R is a hydrophobe, AO is a hydrophile, Z is a nonionic or anionic capping group, n is an integer of from 1 to 200 and m is an integer of from 1 to 3. The cleaning composition and method is effective for removing built-up residue and scum deposited by both positive-working photoresist and negative-working photoresist. Such residue and scum contain photoinitiators, dyes, and (meth)acrylic monomers.

### BACKGROUND OF THE INVENTION

The present invention is directed to a composition and method for cleaning built-up organic residues from a substrate. More specifically, the present invention is directed to a composition and method for cleaning built-up organic residues that are difficult to emulsify.

Contaminants such as built-up organic residue and scum present difficult cleaning problems for various industries. One such industry is the electronics industry where organic residue and scum from photoresist can build-up on various products and apparatus. Photoresist materials are employed in the manufacturing of semiconductor devices, and electronic components such as integrated circuits, photomasks for the manufacture of integrated circuits, printed wiring boards and the like as well as planographic printing plates. In photolithographic processing, a step in the process of making electronic devices and components, a substrate surface is coated with a photoresist, i.e., a coating composition that is sensitive to actinic radiation, e.g., ultraviolet light, X-rays, electron beams and the like, to give a layer that is sensitive to actinic radiation which is irradiated pattern-wise with the actinic radiation. The irradiated photoresist is then developed with a developer solution to form a patterned photoresist layer that serves to selectively protect the substrate surface from etching, plating or diffusion of dopants.

Photoresists may be positive-working, or negative-working. Such photoresists may be liquid, or dry film. A photoresist composition of the positive-working type has such a photosensitivity that solubility of the composition in the developer solution is increased by exposure to light so that the patterned photoresist layer is formed on the areas unexposed to ultraviolet light where the composition is left undissolved. A negative-working photoresist composition exhibits behavior of a sensitivity and solubility that is the reverse of the positive-working photoresist.

Along with recent progress in the technology of semiconductor devices with a requirement for finer and finer high-fidelity patterning of a line width of 1 micron or even finer to comply with the trend of increased density of integration in semiconductor devices, photolithographic processes of patterning using a positive-working photoresist also envisages a difficult problem. When patterning is desired of an extremely fine contact hole in a fine pattern, alkaline developer solution is admixed with a surface active agent with an object to increase the wettability of the substrate surface with the aqueous developer solution. One of the problems in the addition of a surface active agent to the developer solution is that film residues and scums sometimes occur on the exposed areas where the photoresist layer should be dissolved away as completely and cleanly as possible. Although the film residues and scums can be removed by gently treating the surface with oxygen plasma or sputtering, no complete solution of the problem can be obtained by such methods because such treatments must be performed under well controlled troublesome conditions and is not efficient in respect of smooth removal of the scums, or gives no uniform effect of treatment in finely patterned areas having contact holes of about 1 micron or smaller in diameter.

U.S. Pat. No. 4,820,621 to Tanaka et al. has addressed the problem of residue and scum formation by modifying a developer solution with the addition of a non-ionic surface active agent that is a polyoxyethylene alkyl-substituted phenyl ether. The ether is included in the developer solution in an amount of from 50 to 5000 ppm (parts per million). The developer solution is employed in patterning using a positive-working photoresist composition composed of an alkali-soluble novolac resin and a naphthoquinone diazide compound. The '621 patent alleges that patterning the positive photoresist with the developer containing the polyoxyethylene alkyl-substituted phenyl ether prevents formation of residues and scums after development.

Similar residue and scum formation also occur when negative-working photoresists are employed. For example, in manufacturing printed circuit boards UV curable negative-working photoresists may be used. Exposed portions of the photoresist become insoluble in alkaline developer solution and form a protective barrier to other processing chemicals such as etching and plating solutions. Unexposed portions of the photoresist are to rinse freely from the circuit board with an alkaline solution such as a 1% sodium carbonate, monohydrate in water. Development occurs because polymers in the photoresist contain acid functionality. Such acid functionality within the polymers are neutralized in alkaline solution forming a water soluble organic salt. As the dissolved photoresist builds up in solution (developer loading), insoluble organic materials begin to form in the developing tank eventually forming a water insoluble residue or scum. Presence of anti-foam additives (conventionally added to developing solutions to minimize foaming) greatly increases the tendency for residue and scum to form. As the level of scum builds, chances increase for an inadvertent redeposit of these water insoluble residues onto the developed circuit board. Such redeposited residues cause a retardation of the etching solution (etching chemistries have difficulty penetrating any organic residues). Where etch is retarded, circuit shorts form causing a defective circuit board. In addition to increasing the potential for defective circuit boards, the residue also makes cleaning equipment difficult, thus increasing maintenance time.

In addition to the problem of built-up residue and scum formation from primary photoresists, there also is a residue and scum build-up problem from secondary photoresists. Such secondary photoresists may be employed in soldermasks. Residue and scum are deposited on a substrate as a result of component separation in the soldermask. Such component separation may be exacerbated when an improperly balanced soldermask developer solution, i.e., improper developing conditions and/or soldermask developer solution chemistry, contact the soldermask. Built-up residue and scum from secondary photoresists often appear as a bright green coating on a substrate such as a developer apparatus.

U.S. Pat. No. 5,922,522 to Barr et al.; U.S. Pat. No. 6,063,550 to Lundy et al.; and U.S. Pat. No. 6,248,506 B1 to Lundy et al. disclose surfactant and surfactant mixtures included a developer solutions that prevent or inhibit the formation of residues and scum on circuit boards and circuit board manufacturing equipment. Such surfactants are composed of a hydrophobic group, an alkoxylated hydrophilic group and a nonionic or anionic capping group. Examples of suitable hydrophobic groups include nonylphenol, octylphenol and tristyrylphenol. Examples of suitable alkoxylated hydrophilic groups include ethylene oxide, propylene oxide and ethylene oxide/propylene oxide groups. Examples of suitable capping groups include hydroxyl, carboxyl, sulfonyl, phosphonyl, or mixtures thereof. Such residue and scum reducing compounds are included in developer solutions in amounts of from about 0.05% to about 1.0% by weight.

Although the developer solutions disclosed in U.S. Pat. No. 5,922,522; U.S. Pat. No. 6,063,550; and U.S. Pat. No. 6,248,506 B1 provide an effective means of reducing the amount of build-up of residue and scum on substrates containing photoresist, such as circuit boards, and equipment used in the manufacture of electronic components, there is still a need for a composition and method for cleaning or removing built-up residue and scum from various substrates such as developer apparatus. Regardless of the efforts to prevent build-up of residue and scum in developer apparatus such as a conventional spin developer, or a spray developer where developer solution is sprayed onto a substrate surface, repeated use of such apparatus inevitably results in the build-up of residue and scum. At a certain point the residues and scum accumulate to such an extent that the equipment is shut down for cleaning, thus reducing product output. Such residue and scum include hydrophobic aromatic materials such as photoinitiators, dyes, (meth)acrylic monomers and other organic materials that make up photoresists. Such residue and scum are often difficult to emulsify with conventional developer apparatus cleaners.

Conventional cleaners used to remove residue and scum may vary in composition. Typically, such conventional cleaners include as active ingredients a strong base such as sodium hydroxide, and chelating agents such as ethylene diamine tetraacetate (EDTA). Surfactants, solvents and emulsifying agents may also be included in the cleaners. Conventional cleaners are employed at temperature ranges from about 45° C. to about 55° C. Such conventional cleaners are primarily used because of the low cost of their ingredients. However, workers in the field using such conventional cleaners have discovered that the residue problem is often made worse. Often the equipment has to be manually cleaned to remove the residue from the photoresist as well as the conventional cleaners. Such manual cleaning is both a labor and time intensive operation that can cause a significant loss of production time. Further, as mentioned above, such cleaners are not effective enough for removing residue from new generation photoresists that have many hydrophobic aromatic materials.

An additional problem associated with cleaning a developer apparatus is an environmental problem. A developer apparatus is cleaned by removing an entire photoresist loaded developer bath (e.g. 100 gallons). (4 quarts=1 gallon, and there are 0.9463 liters/quart.) The developer bath is then loaded with a cleaner solution (100 gallons) resulting in a total of 200 gallons of waste to be treated and disposed of. To treat the waste, a mixture of sulfuric acid, sodium hydroxide and ferrous sulfate is added to form a precipitate. The precipitate is then disposed of according to State and Federal regulations to avoid or limit the risk of environmental contamination. Also, large volumes of water are often employed as rinse during cleaning, thus adding to the waste problem. Additionally, cleaning temperatures of from about 45° C. to about 55° C. result in costly energy expenditure. Large volumes of 100 gallons or more take large amounts of energy and time to heat up to the cleaning temperatures. Such steps are both time consuming and costly to the industry and compromise the efficiency of electronic device manufacturing. Accordingly, there is a need for a cleaning composition and method to remove residue and scum that has built-up on equipment used in manufacturing electronic devices.

### SUMMARY OF THE INVENTION

The present invention is directed to a cleaning composition containing a sufficient amount of a cleaning compound to remove organic residue from a substrate, the cleaning compound has the general formula:

R—[O-(AO)ₙ]ₘ—Z

where R is a hydrophobe, AO is a hydrophile where A is a hydrocarbon group, Z is a nonionic or anionic capping group, n is an integer of from 1 to 200, and m is an integer of from 1 to 3. In addition to the compounds of the general formula, the cleaning composition also may contain secondary surfactants and antifoam agents as well as other adjuvants. The present invention also is directed to a method of cleaning organic residue from a substrate by contacting the organic residue with a sufficient amount of the foregoing compounds to remove the organic residue from the substrate.

Advantageously, compounds having a hydrophobic group, hydrophilic group and capping group as described by the foregoing formula are effective in removing organic residues deposited by both positive-working and negative-working photoresist from a substrate. Such substrates include, but are not limited to, developer apparatus used in applying developer solution to a photoresist as well as other apparatus used in the manufacture of printed wiring boards. Examples of developer apparatus include, but are not limited to, spray developers where developer is sprayed onto a photoresist, or conventional spin developers, immersion developers, or a batch or feed-and-bleed operation apparatus, and the like.

Continuous or prolonged use of equipment employed in applying photoresist or that contacts photoresist during the manufacture of photolithographic devices such as printed wiring boards results in the build-up of undesirable residue on the equipment. The built-up residue may block or clog lines or movable parts on the equipment resulting in production shutdown. Additionally, the residue build-up on printed wiring boards causes defects in the boards such as electrical shorts. Although some solutions that are used in equipment, such as developer solutions, may include compounds that reduce the amount of contaminants that build-up on equipment, in time sufficient amounts of residue or scum build-up such that the equipment requires cleaning. Thus compounds used to reduce residue build-up are no longer effective in maintaining efficient product out-put. Cleaning done with conventional cleaners is not always effective because residue and scum contain chemicals that are difficult to re-emulsify with conventional cleaners. Also, conventional cleaners may further contaminate the equipment and manufactured articles.

Another problem associated with cleaning equipment of built-up residue and scum is disposal of waste. Waste treatment involves the use of costly on-site waste treatement systems. Also, waste from cleaning may present a hazard to the environment and is disposed of at special sites in accordance with local, State and Federal laws. Disposal procedures may be costly due to trucking waste material to disposal sites. The composition and method of the present invention reduce the amount of waste incurred during cleaning, thus providing an environmental and economic advantage.

Accordingly, a primary objective of the present invention is to provide for an improved cleaning composition.

Another objective of the present invention is to provide for an improved cleaning composition that removes the built-up residue and scum from a substrate.

A further objective of the present invention is to provide for a cleaning composition that removes built-up residue and scum caused by photoresist from equipment used in photolithography.

An additional objective of the present invention is to provide for an improved method of cleaning built-up residue and scum from a substrate.

Still yet a further objective of the present invention is to provide for a method of cleaning built-up residue and scum from a substrate that is both economically and environmentally advantageous.

Other advantages may be ascertained by a person of skill in the art reading the following description of the invention and the appended claims.

### BRIEF DESCRIPTION OF THE DRAWINGS

FIGURE shows a photograph of residue filtered from a solution treated with a cleaning composition of the present invention versus a non-treated solution.

### DETAILED DESCRIPTION OF THE INVENTION

A cleaning composition having a compound of the following general formula:

R—[O-(AO)ₙ]ₘ—Z (I)

where R is a hydrophobe, AO is a hydrophile where A is a hydrocarbon group, Z is a noionic or anionic capping group, n is an integer of from 1 to 200, and m is an integer of from 1 to 3 and where the compound is included in the cleaning composition in a sufficient amount to remove built-up residue and scum from a substrate. Preferably n is an integer of from 4 to 80, and m is preferably an integer of 1.

The hydrophobe R may be linear or branched (C₁ to C₂₄) alkyl unsubstituted or substituted, or a unsubstituted or substituted (C₆ to C₁₄) aryl. When hydrophobe R is substituted, it is substituted at one or more carbon atoms. Substituent groups include, but are not limited to, one or more of halogen, such as bromine, chlorine, fluorine, and iodine, phenyl, styrylphenyl, or hydroxyl. Aromatic substituent groups such as the phenyl or styrylphenyl also may be substituted. Substituent groups include, but are not limited to, one or more of halogen, linear or branched (C₁ to C₁₈) alkyl, hydroxyl, or linear or branched (C₁ to C₆) alkoxy. Preferred hydrophobe groups include nonylphenyl, octylphenyl, monostyrylphenyl, distyrylphenyl and tristyrylphenyl with tristyrylphenyl the most preferred hydrophobe.

Variable A of hydrophilic component AO may be linear or branched (C₁ to C₆) hydrocarbon with (C₂ to C₃) the preferred carbon chain length. Examples of suitable alkylene oxide units include ethylene oxide and propylene oxide. A also may be a radical —CH₂—CH(—CH₃)—O—CH₂—CH₂—, or —CH₂—CH₂—CH₂—O—CH₂—CH₂— such that AO is a mixture of ethylene and propylene oxide units.

Z may be hydrogen to form a nonionic capping component, or an anionic capping component such as a carboxylate, sulfonate, sulfate, phosphate ester including free acid and salt thereof. Cationic counterions include, but are not limited to, sodium, potassium, calcium, barium, ammonium, triethylammonium, or quaternary amines. Preferably Z is hydrogen, sulfate, or phosphate ester.

Examples of suitable cleaning compounds that may be used to practice the present invention include, but are not limited to, tristyrylphenol ethoxylate (8 moles of ethylene oxide), tristyrylphenol ethoxylate (16 moles of ethylene oxide), tristyrylphenol ethoxylate (20 moles of ethylene oxide), tristyrylphenol ethoxylate (25 moles of ethylene oxide), tristyrylphenol ethoxylate (40 moles of ethylene oxide), tristyrylphenol ethoxylate/propoxylate, tristyrylphenol ethoxylate phosphate ester (free acid), tristyrylphenol ethoxylate phosphate ester (potassium salt), and ammonium tristytrylphenol ethoxy sulfate. Such compounds may be prepared by known methods in the art, or obtained commercially under the trade name product Soprophor® (obtainable from Rhodia).

In addition to the cleaning compound described above, the cleaning composition may also contain adjuvants to assist the cleaning compound. Such adjuvants include, but are not limited to, secondary surfactants and antifoam agents. Examples of such secondary surfactants include, but are not limited to, quaternary ammonium salts, water soluble or water dispersable polymers, or surfactants having the following general formula:

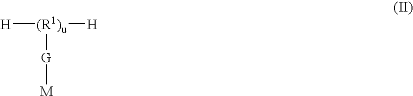

where R¹ is a (C₁ to C₆) alky or (C₆ to C₁₄) aryl group, G is a carboxyl, sulfonyl, or phosphonyl, M is a charge-balancing cation such as sodium, potassium, or ammonium, and u is an integer of from 1 to 200, preferably an integer of from 2 to 200. When u is an integer of 2 or greater, G may be the same or different. An example of such surfactants is Newkalgen® TX-C (obtainable from Takemoto Oil and Fat Co.) which is a phenolic sulfonyl salt. Other suitable secondary surfactants include, but are not limited to, alcohol alkoxylates, amine alkoxylates, fatty alcohol alkoxylates, fatty sorbitan esters and their alkoxylates, amphoteric surfactants, and the like. Examples of two commercially available surfactants are the ethylene oxide and propylene oxide surfactants Pluronic® and Tetronic® (obtainable from BASF).

Antifoam agents that may be employed include, but are not limited to, such agents as Morton 2750 Antifoam® and Antifoam® 80 both obtainable from Morton International.

Cleaning compositions of the present invention remove built-up organic residue and scum from a substrate by contacting the built-up residue and scum with a sufficient amount of a cleaning composition such that the built-up residue and scum are solubilized by the cleaning composition. Agitation also may be employed if needed to help loosen residue and scum from a substrate. While cleaning compounds of the present invention may be employed to clean at amounts of from about 0.1% by weight to about 100% by weight (as a concentrate), in general, cleaning compounds described in formula I above are employed to remove built-up residue and scum at concentration ranges of from about 0.1% by weight to about 35% by weight of the cleaning composition. In general, concentrations of compound I of from 2% by weight to about 8% by weight of the cleaning composition are preferred. Adjuvants, as described above, may be employed in the cleaning composition in conventional amounts. For example, secondary surfactants may be employed in amounts of from about 1% by weight to about 50% by weight. Antifoam agents may be employed in amounts of from about 0.001% by weight to about 1.0% by weight. The balance of the cleaning composition is a solvent. Water is a preferred solvent, however organic solvents such as alcohols and ketones and the like also may be employed. A preferred cleaning composition of the present invention consists essentially of a compound of formula I, a secondary surfactant, an antifoam agent and a solvent.

Optionally, after cleaning a substrate of built-up residue and scum with the cleaning composition of the present invention, the substrate may be rinsed with water to remove loosened residue and scum remaining on the substrate. However, the amount of rinse water employed in the rinse may be about half the amount as that used with conventional cleaners. The cleaning composition and method of the present invention may remove from about 85% by weight to about 98% by weight of built-up residue and scum from a substrate.

Surprisingly, the cleaning compositions of the present invention remove built-up organic residue and built-up organic scum from both positive-working (both liquid and dry film) and negative-working photoresist (both liquid and dry film). Such built-up organic residue and organic scum on a substrate are difficult to remove with conventional cleaners and surfactants because of the types of chemicals used in photoresists, in particular the new generation of photoresists which contain many compounds of a hydrophobic aromatic character.

Additionally, the cleaning compositions of the present invention also remove built-up residues deposited by secondary photoresists from a substrate. Such photoresist may be employed in soldermasks. Residue and scum are deposited on a substate as a result of component separation in the soldermask. Such component separation may be exacerbated when an improperly balanced soldermask developer solution, i.e. improper developing conditions and/or soldermask developer solution chemistry, contact the soldermask. Residue and scum build-up on such substrates as printed wiring boards and soldermask developer apparatus. Built-up residue and scum may appear as a bright green coating on developer apparatus surfaces. The bright green coating comes from an oily layer of water insoluble material from the secondary photoresist in which pigment from the photoresist concentrates. Generally, there is a higher level of hydrophobic aromatic compounds in secondary photoresist formulations than primary photoresist formulations. Thus cleaning residue and scum deposited by secondary photoresists is a further improvement and advantage over conventional cleaners.

While not being bound to any particular theory, the aromatic and hydrophobic character of components that compose many photoresists in turn generate residue and scum with hydrophobic character. Such hydrophobic materials prefer to be amongst themselves in a separate organic phase as opposed to residing in an aqueous phase. Once such hydrophobic materials come out of an aqueous solution, such as developer solution, re-emulsifying them in an aqueous phase is difficult because the hydrophobic materials have broken their emulsion form. Cleaning compositions of the present invention re-emulsify such residue and scum.

Residues and scum from photoresist include, but are not limited to, such chemical materials as hydrophobic aromatic materials such as photoinitiators, thermoinitiators, dyes, acrylic, and methacrylic monomers. Photoinitiators such as photoacid generators, photobase generators or free-radical generators once built-up as residue or scum on a substrate are more difficult to remove than many of the other components that compose the residue and scum. Such materials do not readily re-emulsify once they build-up on a substrate such as photolithographic manufacturing apparatus.

Photoresists vary in composition. Generally, a photoresist composition may compose from about 20% to about 90% by weight of a binder polymer, about 15% to about 50% by weight of α,β-ethylenically unsaturated compounds (cross-linkers) such as monomers and short-chain oligomers and from about 0.1% to about 25% by weight of a photoinitiator or photoinitiator chemical system. Liquid photoresists may contain a larger concentration of binder in relation to monomers or short-chain oligomers whereas dry film may contain larger concentrations of monomers or short-chain oligomers. Such concentrations are known in the art. Other components employed in a photoresist that may contribute to residue and scum build-up are discussed below. Built-up residue and scum from liquid photoresist appears as crystalline material on a substrate. Such built-up residue and scum may be removed with cleaning compositions containing a cleaning compound of formula I in a concentration range of from about 0.1% by weight to about 35% by weight, preferably from about 0.2% by weight to about 0.8% by weight of the cleaning composition or cleaning bath. Built-up residue from dry film as well as secondary photoresists may be removed from a substrate at concentrations of a compound of formula I of from greater than 1.0% by weight to about 35% by weight of the cleaning composition or bath. Preferably, a compound of formula I may be employed at a concentration of from about 2% to about 8% by weight of the cleaning composition to remove built-up residue and scum generated from dry film or secondary photoresists.

Examples of components that compose a photoresist that may cause undesirable built-up residue or scum on a substrate include, but are not limited to, polymeric binders such as those containing as polymerized units one or more ethylenically or acetylenically unsaturated monomers. Examples of monomers include, but are not limited to: (meth)acrylic acid, (meth)acrylamides, alkyl (meth)acrylates, alkenyl (meth)acrylates, aromatic (meth)acrylates, vinyl aromatic monomers, nitrogen-containing compounds and their thio-analogs, substituted ethylene monomers, cyclic olefins, substituted cyclic olefins, and the like. Preferred monomers include (meth)acrylic acid, alkyl (meth)acrylates and vinyl aromatic monomers. Such polymeric binders may be homopolymers or copolymers and preferably copolymers.

Cross-linkers that may cause residue or scum build-up include di-, tri-, tetra-, or higher multi-functional ethylenically unsaturated monomers. Examples of such cross-linkers include, but are not limited to: trivinylbenzene, divinyltoluene, divinylpyridine, divinylnaphthalene and divinylxylene; and such as ethyleneglycol diacrylate, trimethylolpropane triacrylate (“TMPTA”), diethyleneglycol divinyl ether, trivinylcyclohexane, allyl methacrylate (“ALMA”), ethyleneglycol dimethacrylate (“EGDMA”), diethyleneglycol dimethacrylate (“DEGDMA”), propyleneglycol dimethacrylate, propyleneglycol diacrylate, trimethylolpropane trimethacrylate (“TMPTMA”), divinyl benzene (“DVB”), glycidyl methacrylate, 2,2-dimethylpropane 1,3 diacrylate, 1,3-butylene glycol diacrylate, 1,3-butylene glycol dimethacrylate, 1,4-butanediol diacrylate, diethylene glycol diacrylate, diethylene glycol dimethacrylate, 1,6-hexanediol diacrylate, 1,6-hexanediol dimethacrylate, tripropylene glycol diacrylate, triethylene glycol dimethacrylate, tetraethylene glycol diacrylate, polyethylene glycol 200 diacrylate, tetraethylene glycol dimethacrylate, polyethylene glycol dimethacrylate, ethoxylated bisphenol A diacrylate, ethoxylated bisphenol A dimethacrylate, polyethylene glycol 600 dimethaerylate, poly(butanediol) diacrylate, pentaerythritol triacrylate, trimethylolpropane triethoxy triacrylate, glyceryl propoxy triacrylate, pentaerythritol tetraacrylate, pentaerythritol tetramethacrylate, dipentaerythritol monohydroxypentaacrylate, ethoxylated diacrylates, ethoxylated triacrylates such as ethoxylated TMPTA and ethoxylated TMPTMA, ethoxylated tetraacrylates, divinyl silane, trivinyl silane, dimethyl divinyl silane, divinyl methyl silane, methyl trivinyl silane, diphenyl divinyl silane, divinyl phenyl silane, trivinyl phenyl silane, divinyl methyl phenyl silane, tetravinyl silane, dimethyl vinyl disiloxane, poly(methyl vinyl siloxane), poly(vinyl hydro siloxane), poly (phenyl vinyl siloxane), glycosyl ureas including di-, tri- and tetra-glycosyl ureas, epoxies and mixtures thereof. Such cross-linking agents are generally commercially available.

Photoimageable compositions contain one or more photoactive components. The photoactive components may be photoacid generators, photobase generators or free-radical generators. Such photoactive components are a major source of scum formations.

Example of photoacid generators include halogenated triazines, onium salts, sulfonated esters, halogenated sulfonyloxy dicarboximides, diazodisulfones, α-cyanooxyaminesulfonates, imidesulfonates, ketodiazosulfones, sulfonyldiazoesters, 1,2-di(arylsulfonyl)hydrazines and the like.

Free-radical generators include, but are not limited to, n-phenylglycine, aromatic ketones such as benzophenone, N,N′-tetramethyl-4,4′-diaminobenzophenone [Michler's ketone], N,N′-tetraethyl-4,4′-diaminobenzophenone, 4-methoxy-4′-dimethylaminobenzophenone, 3,3′-dimethyl-4-methoxybenzophenone, p,p′-bis(dimethylamino)benzophenone, p,p′-bis(diethylamino)-benzophenone, anthraquinone, 2-ethylanthraquinone, naphthaquinone and phenanthraquinone, benzoins such as benzoin, benzoinmethylether, benzoinethylether, benzoinisopropylether, benzoin-n-butylether, benzoin-phenylether, methylbenzoin and ethybenzoin, benzyl derivatives such as dibenzyl, benzyldiphenyldisulfide and benzyldimethylketal, acridine derivatives such as 9-phenylacridine and 1,7-bis(9-acridinyl)heptane, thioxanthones such as 2-chlorothioxanthone, 2-methylthioxanthone, 2,4-diethylthioxanthone, 2,4-dimethylthioxanthone and 2-isopropylthioxanthone, acetophenones such as 1,1-dichloroacetophenone, p-t-butyldichloro-acetophenone, 2,2-diethoxyacetophenone, 2,2-dimethoxy-2-phenylacetophenone, and 2,2-dichloro-4-phenoxyacetophenone, 2,4,5-triarylimidazole dimers such as 2-(o-chlorophenyl)-4,5-diphenylimidazole dimer, 2-(o-chlorophenyl)-4,5-di(m-methoxyphenyl imidazole dimer, 2-(o-fluorophenyl)-4,5-diphenylimidazole dimer, 2-(o-methoxyphenyl)-4,5-diphenylimidazole dimer, 2-(p-methoxyphenyl)-4,5-diphenylimidazole dimer, 2,4-di(p-methoxyphenyl)-5-phenylimidazole dimer, 2-(2,4-dimethoxyphenyl)-4,5-diphenylimidazole dimer and 2-(p-methylmercaptophenyl)-4,5-diphenylimidazole dimer, and the like. Though, not a free-radical generator, triphenylphosphine may be included in the photoactive chemical system as a catalyst.

Optional additives that may be used in photoimageable compositions and that cause residue and scum include, but are not limited to: anti-striation agents, plasticizers, speed enhancers, fillers, dyes, film forming agents, non-polymerizable organic acids and the like. Suitable plasticizers include esters such as dibenzoate esters. Non-polymerizable organic acids may also be added to photoresist compositions. Such organic acids are substantially non-polymerizable with the polymeric binders, optional cross-linking agents or both. A wide variety of organic acids may suitably be added to photoresist compositions. Suitable organic acids include, but are not limited to, alkanecarboxylic acids and arylcarboxylic acids, sulfonic acids such as alkanesulfonic acids and arylsulfonic acids, phosphonic acids such as alkylphosphonic acids and arylphosphonic acids, and the like. Exemplary carboxylic acids include, but are not limited to, (C₁-C₁₂)alkylcarboxylic acids, (C₁-C₁₂)alkyldicarboxylic acids, (C₁-C₁₂)alkyltricarboxylic acids, substituted (C₁-C₁₂)alkylcarboxylic acids, substituted (C₁-C₁₂)alkyldicarboxylic acids, substituted (C₁-C₁₂)alkyltricarboxylic acids, amine carboxylic acids such as ethylenediamine tetraacetic acid, arylcarboxylic acids such as arylmonocarboxylic acids, aryldicarboxylic acids and aryltricarboxylic acids, and substituted arylcarboxylic acids. Preferred organic acids include formic acid, acetic acid, propionic acid, oxalic acid, malonic acid, succinic acid, glutaric acid, adipic acid, glycolic acid, lactic acid, tartaric acid, citric acid or malic acid, ethylenediamine tetraacetic acid, phthalic acid, benzene tricarboxylic acid, salicilic acid, cyclohexanecarboxylic acid, 1,4-cyclohexanedicarboxylic acid and sebacic acid.

A wide variety of photoresist strip enhancers also may be used in photoresists. Such strip enhancers may contribute to residue and scum build-up. Examples of photoresist strip enhancers are compounds containing one or more trihalomethyl-substituents in an alpha position relative to a group capable of stabilizing a negative charge.

In one embodiment a cleaning composition of the present invention may be used to clean residue and scum of photoresist built-up on a developer apparatus. Such apparatus are well known in the electronics industry. Developer apparatus are employed to apply a composition of developer solution and photoresist to a substrate such as a printed wiring board. Developer solutions contain bases such as sodium carbonate or potassium carbonate, an antifoam agent and water. Additionally, developer solutions may contain compounds intended to prevent or inhibit the formation of residue and scum from photoresist. Examples of such residue reducing agents are disclosed in U.S. Pat. No. 6,248,506 B1, U.S. Pat. No. 6,063,550, and U.S. Pat. No. 5,922,522, the entire disclosures of which are hereby incorporated herein in their entireties by reference. Although such residue reducing compounds are effective in reducing the amount of residue and scum build-up, repeated and continuous use of developer apparatus still leads to build-up of difficult to remove residue and scum. After repeated and continuous use for about 200 hours to about 400 hours or more, the developer apparatus is cleaned to remove the built-up residue and scum.

Cleaning involves filling the developer apparatus with a sufficient amount of a cleaning composition to remove the built-up residue and scum. Suitable concentrations of components that compose the cleaning compositions to remove built-up residue and scum are described above. Alternatively, the cleaning composition may be mixed with developer solution in the developer apparatus. A sufficient amount of developer solution is removed from the developer apparatus such that the cleaning composition composes from about 10% by volume to about 100% by volume of the now formed cleaning bath. Preferably, the cleaning composition composes from about 25% by volume to about 45% by volume of the cleaning bath. The cleaning bath is circulated through the developer apparatus for a sufficient amount of time to remove built-up residue and scum, preferably for about 15 minutes to about 60 minutes. Advantageously, the cleaning compositions of the present invention may be employed to clean residue and scum from a substrate at temperatures of from about 20° C. to about 30° C. At such low temperatures less energy is required to clean a surface in contrast to conventional cleaners which are used at such high temperatures of about 45° C. to about 55° C. Thus, the method of the present invention is economically advantageous over conventional cleaning. However, the method of the present invention may be performed at temperatures in excess of 30° C. if desired.

Optionally, the developer apparatus may be rinsed with water after the cleaning bath is drained from the developer apparatus to remove any loose residue and scum that did not drain from the apparatus with the cleaning bath. The developer apparatus is determined sufficiently cleaned when the water rinse is transparent to the naked eye. An insufficiently cleaned apparatus has turbid rinse water.

Advantageously, the cleaning composition and method of the present invention provides for a method of removing built-up organic residue and organic scum from a substrate. The cleaning composition is highly effective for removing built-up organic residue and organic scum of photoresist from a substrate such as equipment used in manufacturing printed wiring boards. The cleaning composition and method may remove up to 98% by weight of undesirable built-up organic residue and scum from a substrate. The cleaning composition and method of the present invention eliminates the use of conventional cleaners that may further aggravate contamination of equipment and printed wiring boards. The present invention provides for a more efficient manufacturing process since less time is involved in cleaning equipment, and less waste is generated thus providing for a more environmentally friendly cleaning composition and method. Additionally, the cleaning compositions of the present invention may clean built-up residue and scum from a substrate at lower temperatures then conventional cleaners. Accordingly, the cleaning composition and method of the present invention is more energy efficient.

While the present invention is described in the context of cleaning organic residue and scum in the electronics industry, the cleaning compositions of the present invention may be employed to clean organic residue and organic scum for any substrate.

The following examples are intended to further illustrate the present invention and are not intended to limit the scope of the invention.

### EXAMPLE 1

Ten aqueous solutions were prepared in one liter beakers composed of about 3.53 grams of a dry film photoresist composed of about 51% by weight of acrylic copolymer, about 37% by weight of acrylic monomer with the remainder of the photoresist containing photoinitiators (benzophenone, Michler's ketone, and a lophine dimmer) a leuco dye and conventional additives. The ten solutions also contained about 200 ml, total volume, of about 1% by weight alkali developer solution (active component was sodium carbonate). Each solution was bubbled for about 5 hours with air to encourage residue formation. Bubbling simulates mechanical action of a developer apparatus. The ten solutions were left at room temperature (about 20° C.) for about 24 hours to allow time for residue and scum to build-up.

After about 24 hours, each of the ten beakers containing the developer solutions was examined for residue and scum formation. Each solution had a medium blue turbid appearance. The blue color was due to the dye in the photoresist. The top and bottom of each solution contained large particles of photoresist residue. The bottoms of each beaker contained a pasty residue or scum derived from the photoresist. Much of the residue and scum was believed to be due to monomers, photoinitiators, and dye components, especially the photoinitiators which contain hydrophobic aromatic groups as part of their chemical structure.

Nine aqueous cleaning solutions were prepared that contained about 15% by weight of a tristyrylphenol alkoxy cleaning compound. The compounds used to make the cleaning composition are listed in the Table below.

About 86 ml (about 30 volume percent) from each of the nine cleaning solutions was added to one of each of nine 200 ml solutions containing the photoresist (about 70 volume percent). The remaining aqueous solution with the photoresist was used as a control, and was not treated with one of the nine cleaning solutions. The solutions were mixed together to form a uniform solution and stored at room temperature (about 20° C.) for about 24 hours. After about 24 hours of storage, the solutions were observed for residue and scum followed by filtering the solutions, and drying and weighing the residue from the solutions. The results are shown in the Table below.

TABLE

| | Chemical | Top of | Side of | Bulk of | Bottom of | Residue |
|---|---|---|---|---|---|---|
| Mixture | Description of | Solution, | Container, | Solution, | Container, | Weight |
| Number | Additive | Overnight | Overnight | Overnight | Overnight | (mg) |
| 1 | Control, | Large | Large | Medium | Large amount | 73.6 |
| | No addition | amount of | amount of | blue, | of particles and | |
| | | particles | particles | turbid | pasty reside | |
| 2 | Tristyrylphenol | Clean | Clean | Somewhat | Moderate | 9.5 |
| | ethoxylate, 8 moles | | | turbid, | amount of | |
| | ethylene oxide | | | light | whitish residue | |
| | | | | blue/gray | | |
| 3 | Tristyrylphenol | Clean | Clean | Dark blue, | Small/moderate | 3.9 |
| | ethoxylate, 16 moles | | | transparent | amount of | |
| | ethylene oxide | | | | particles | |
| 4 | Tristyrylphenol | Few | Few | Dark blue, | Moderate | 8.3 |
| | ethoxylate, 20 moles | particles | Particles | transparent | amount of | |
| | ethylene oxide | | | particles | | |
| 5 | Tristyrylphenol | Moderate | Few | Dark blue, | Small/moderate | 4.0 |
| | ethoxylate, 25 moles | amount of | Particles | transparent | amount of | |
| | ethylene oxide | particles | | particles | | |
| 6 | Tristyrylphenol | Large | Large | Dark blue, | Small amount | 7.4 |
| | ethoxylate, 40 miles | amounts | amount | of transparent | of particles | |
| | ethylene oxide | of | particles | | | |
| | | particles | | | | |
| 7 | Tristyrylphenol | Few | Few | Dark blue, | Small amount | 5.1 |
| | ethoxylate/propoxylate | particles | particles | transparent | of particles | |
| 8 | Tristyrylphenol | Clean | Clean | Dark blue, | Moderate | 2.9 |
| | ethoxylate phosphate | | | transparent | amount of | |
| | ester, acid free | | | | particles | |
| 9 | Tristyrylphenol | Clean | Clean | Dark blue, | Moderate | 4.3 |
| | ethoxylate phosphate | | | transparent | amount of | |
| | ester, potassium salt | | | | particles | |
| 10 | Ammonium | Moderate | Moderate | Dark blue, | Moderate | 5.6 |
| | tristyrylphenol ethoxy, | amount of | amount of | transparent | amount of | |
| | sulfate, 16 moles of | particles | particles | | particles | |
| | ethylene oxide | | | | | |

Eight of the solutions that were mixed with the cleaning compositions had a dark blue transparent solution in contrast to the control which had a turbid medium blue appearance. Solution 2 had a somewhat turbid, light blue/gray appearance. The transparent appearance indicated that the built-up residue and scum were solubilized by the cleaning composition. Mixtures 2, 3, 8, and 9 had both a residue free top (clean) and residue free container side (clean) in contrast to the control solution which had large amounts of particles. The bottoms of the containers of mixtures 3, 8 and 9 had from small to moderate amounts of particles without any pasty residue in contrast to the control. Mixture 2 had a moderate amount of whitish residue.

Mixtures 4 and 7 had a few particles at the top of the mixture and at the side of the container with a moderate amount of particles at the bottom of the container in mixture 4, and a small amount of particles in mixture 7. In contrast, the control had large amounts of particles with a pasty residue at the bottom of the container.

Mixtures 5 and 10 had moderate amounts of particles at the top of the solutions with few particles at the side of the container in mixture 5, and moderate amounts of particles in mixture 10. The particles at the bottom of the containers for mixtures 5 and 10 were from small to moderate in quantity. No pasty residue was observed at the bottom of the container as in the control.

Mixture 6 had large amount of particles at the top of the solution and at the container side with small amounts of particles at the bottom of the container. As with all the other mixtures no pasty residue was observed at the bottom of the container.

All the mixtures and the control solution were filtered. Residue on the filter paper was dried and weighed. The weight of residue obtained from each solution is recorded in the Table above. The control had the greatest amount of residue, i.e., 73.6 mg, in contrast with the residue obtained from the solutions with the cleaning compositions of the present invention. The residues obtained from the mixture solutions ranged from 2.9 mg to a high of 9.5 mg. The cleaning compositions of the present invention had solubilized large amounts of built-up residue and scum, and allowed the solubilized residue and scum to pass through the filter as filtrate. Thus, the reduction of visible particles in the mixtures, and the lower amounts of residue filtered from the mixtures in contrast to the control showed that the cleaning compositions of the present invention removed built-up residue and scum from a substrate, and clarified the developer solutions.

### EXAMPLE 2

Two 200 ml aqueous solutions were prepared containing photoresist and developer as in Example 1 above. Each solution was bubbled with air as in Example 1. The solutions were allowed to sit overnight to form residue and scum at about 20° C.

About 86 ml of a 15% by weight of tristyrylphenol ethoxylate phosphate ester was added and mixed with one of the contaminated solutions. The second solution acted as a control.

Both solutions were filtered, and the filter from each solution was photographed using a digital camera to record the amount of residue collected from each solution. The FIGURE shows the amount of residue collected from each sample. The sample on the left shows a circular deposit of residue (yellow in color) in the middle of the filter that was filtered from the control. The filter on the right from the solution with the cleaning composition had a clear or non-residue containing center. The residue from the photoresist was solubilized by the cleaning composition and passed through the filter. Thus the cleaning composition cleaned built-up residue.

### EXAMPLE 3

About 100 gallons of an aqueous developer solution composed of about 1% by weight of sodium carbonate and an antifoam agent is loaded with uncured photoresist. The mixture of the developer solution and the uncured photoresist is added to a spray developer apparatus for application to printed circuit boards. The mixture of the developer solution and the uncured photoresist is sprayed onto circuit boards in a continuous process. Developer is replenished in the developer apparatus as needed, and the application process continues until a maximum level of uncured photoresist in the developer solution is reached at which point enough built-up residue and scum accumulate such that the developer apparatus is shutdown and cleaned.

Cleaning involves removing the entire volume of developer solution with uncured photoresist (about 100 gallons), and adding about 100 gallons of a conventional cleaner containing active ingredients sodium hydroxide and EDTA to the developer apparatus. The conventional cleaner is circulated throughout the lines of the developer apparatus to remove the residue and scum. During cleaning a temperature of from about 45° C. to about 55° C. is maintained.

After cleaning, the conventional cleaner (about 100 gallons) is removed from the developer apparatus and sent for hazardous waste treatment. The developer apparatus is then rinsed with about 200 gallons of water. The rinse water is also treated as a hazardous waste.

The total hazardous waste from the foregoing process=about 100 gallons of loaded developer solution+about 100 gallons of developer apparatus cleaner solution+about 200 gallons of water rinse=about 400 gallons.

The method of the present invention reduces the amount of hazardous waste in contrast to the foregoing conventional cleaning method thus providing for an improved cleaning process. Also, cleaning is performed at lower temperatures to reduce energy costs.

When a maximum level of uncured photoresist in the developer solution is reached, the developer apparatus is cleaned by the removal of about 30 gallons of developer solution loaded with uncured photoresist. About 30 gallons of about a 20% by weight tristyrylphenol ethoxylate aqueous solution is added to the remaining developer solution loaded with uncured photoresist, and the mixture is circulated through the developer apparatus to remove the built-up residue and scum. Temperatures employed during cleaning range from about 20° C. to about 30° C.

After cleaning, the mixture of cleaner and developer solution with uncured photoresist (about 100 gallons) is removed from the developer apparatus and sent for hazardous waste treatment. The developer apparatus is rinsed with about 100 gallons of water. The rinse water is sent for hazardous waste treatment.

Total hazardous waste=about 30 gallons of loaded developer solution+about 100 gallons of loaded developer solution mixed with developer cleaner solution+about 100 gallons of rinse water=about 230 gallons.

The cleaning composition and method of the present invention reduces hazardous waste by about 170 gallons or about by 42.5%. Removal of part of the developer solution loaded with uncured photoresist with replacement with a cleaning composition of the present invention reduces total hazardous waste, thus providing an improved cleaning method.

### EXAMPLE 4

About 100 gallons of an aqueous developer solution composed of about 1% by weight of sodium carbonate, about 0.5% by weight of a residue reducing agent, and about 0.05% by weight of an antifoaming agent is placed in a developer apparatus, and loaded with an uncured photoresist. The reducing agent is an alkoxylated emulsifier with a tristyrylphenol hydrophobe moiety. The residue reducing agent inhibits residue formation during operation of the developer apparatus. As in Example 3 above, the developer apparatus is run until cleaning is required to remove built-up residue and scum from all surfaces of the apparatus including walls, pipes, filters, lines and nozzles. Although a residue reducing agent included in the developer solution, some residue and scum builds-up over time.

About 30 gallons of the developer solution with loaded photoresist is removed from the developer apparatus and treated as hazardous waste. The about 30 gallons of volume is replaced with about 30 gallons of aqueous cleaning solution composed of about 15% by weight of tristyrylphenol ethoxylate phosphate ester, free acid. The mixture of the added cleaning solution with the remainder of the developer solution with the loaded uncured photoresist is circulated through the developer apparatus to remove built-up residue and scum.

After cleaning, the cleaner with the developer solution (about 100 gallons) is removed from the developer apparatus and treated as hazardous waste. The developer is rinsed with about 100 gallons of water. The rinse water is treated as hazardous waste.

Total hazardous waste=about 30 gallons of loaded developer solution+about 100 gallons of developer solution loaded with uncured photoresist with cleaner composition+about 100 gallons of rinse water=about 230 gallons of hazardous waste.

Thus, the method of the present invention reduces the amount of hazardous waste in contrast to the conventional method as disclosed in Example 3 above which produces about 400 gallons of hazardous waste. Accordingly, the method of the present invention is more environmentally friendly then the conventional cleaning method, and is an improved cleaning method for removing built-up residue and scum from a developer apparatus. Further, the method and composition of the present invention is an improvement over conventional cleaners, especially in removing residues generated by the new generation of photoresists.

What is claimed is:

1. A cleaning composition comprising a cleaning compound of formula:
R—[O-(AO)ₙ]ₘ—Z
in an amount of from greater than about 1.0% to about 35% by weight of the cleaning composition where R is a hydrophobe group, AO is a hydrophilic group, Z is a nonionic or anionic capping group, n is an integer of from 1 to 200 and m is an integer of from 1 to 3.

2. The cleaning composition of claim 1, wherein R is unsubstituted or substituted, linear or branched (C₁-C₂₄) alkyl unsubstituted or substituted, or unsubstituted or substituted (C₆-C₂₄) aryl.

3. The cleaning composition of claim 2, wherein substituent groups comprise halogen, phenyl, styrylphenyl, or hydroxyl.

4. The cleaning composition of claim 3, wherein the phenyl or styrylphenyl substituent group is substituted with a group comprising halogen, hydroxyl, linear or branched (C₁-C₁₈) alkyl, or linear or branched (C₁-C₆) alkoxy.

5. The cleaning composition of claim 1, wherein A is a linear or branched (C₁-C₆) hydrocarbon group, or —CH₂—CH₂—CH₂—O—CH₂—CH₂— or —CH₂—CH(—CH₃)—O—CH₂—CH₂— radical.

6. The cleaning composition of claim 1, wherein Z is hydrogen.

7. The cleaning composition of claim 1, wherein Z is carboxylate, sulfonate, sulfate, or phosphate ester.

8. The cleaning composition of claim 1, further comprising an antifoam agent.

9. The cleaning composition of claim 1, further comprising a surfactant having a formula: 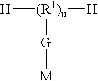
where R¹ is linear or branched (C₁-C₆) alkyl, or (C₆-C₁₄) aryl, G is a carboxyl, sulfonyl, or phosphonyl, M is a charge-balancing cation, and u is an integer of from 1 to 200, where u is an integer of 2 to 200, G may be the same or different.

10. A method of cleaning comprising contacting built-up residue and scum with a cleaning composition comprising a cleaning compound of formula:
R—[O-(AO)ₙ]ₘ—Z
in an amount of from greater than about 1.0% to about 35% by weight of the cleaning composition where R is a hydrophobe, AO is a hydrophile, Z is a nonionic or anionic capping group, n is an integer of from 1 to 200, and m is an integer of from 1 to 3.

11. The method of claim 10, wherein R is unsubstituted, substituted, linear or branched (C₁-C₂₄)alkyl unsubstituted or substituted, or unsubstituted or substituted (C₆-C₁₄) aryl; A is linear or branched (C₁-C₆) hydrocarbon group, or —CH₂—CH₂—CH₂—O—CH₂—CH₂— or —CH₂—CH(—CH₃)—O—CH₂—CH₂—; and Z is hydrogen, carboxylate, sulfonate, sulfate, or phosphate ester.

12. The method of claim 10, wherein the cleaning compound is at a concentration of from 2.0% by weight to about 8.0% by weight of the cleaning composition.

13. The method of claim 10, wherein the cleaning compound comprises tristyrylphenol ethoxylate (8 moles of ethylene oxide), tristyrylphenol ethoxylate (16 moles of ethylene oxide), tristyrylphenol ethoxylate (20 moles of ethylene oxide), tristyrylphenol ethoxylate (25 moles of ethylene oxide), tristyrylphenol ethoxylate (40 moles of ethylene oixde), tristyrylphenol ethoxylate/propoxylate, tristyrylphenol ethoxylate phosphate ester, ammonium tristyrylphenol ethoxy sulfate, or mixtures thereof.

14. A method of cleaning a developer apparatus comprising:
a) removing from about 10% by volume to about 100% by volume of a developer solution from the developer apparatus;
b) adding from about 10% by volume to about 100% by volume of a cleaning composition into the developer apparatus to replace the developer solution that was removed to form a cleaning bath, the cleaning composition comprises a cleaning compound in a sufficient amount to remove built-up residue and scum from the developer apparatus, the cleaning compound has a formula:
R—[O-(AO)ₙ]ₘ—Z
where R is a hydrophobe, AO is a hydrophile, Z is a nonionic or anionic capping group, n is an integer of from 1 to 200, and m is an integer of from 1 to 3; and
c) circulating the cleaning bath through the developer apparatus to remove built-up residue and scum.

15. The method of claim 14, wherein R is unsubstituted, substituted, linear or branched (C₁-C₂₄) alkyl unsubstituted or substituted, or unsubstituted or substituted (C₆-C₁₄) aryl, A is linear or branched (C₁-C₆) hydrocarbon, or —CH₂—CH₂—CH₂—O—CH₂—CH₂— or —CH₂—CH(—CH₃)—O—CH₂—CH₂— radical, Z is hydrogen, carboxylate, sulfonate, sulfate, or phosphate ester.

16. The method of claim 14, wherein the developer solution comprises an alkaline solution, antifoam agent, a residue reducing agent, uncured photoresist, or mixtures thereof.

17. The method of claim 14, wherein the cleaning compound comprises tristyrylphenol ethoxylate (8 moles of ethylene oxide), tristyrylphenol ethoxylate (16 moles of ethylene oxide), tristyrylphenol ethoxylate (20 moles of ethylene oxide), tristyrylphenol ethoxylate (25 moles of ethylene oxide), tristyrylphenol ethoxylate (40 moles of ethylene oxide), tristyrylphenol ethoxylate/propoxylate, tristyrylphenol ethoxylate phosphate ester, ammonium tristyrylphenol ethoxy sulfate, or mixtures thereof.

18. The method of claim 14, wherein the residue and scum comprise photoinitiators, dyes, (meth)acrylic monomers, or mixtures thereof.

19. The method of claim 14, wherein the cleaning composition removes from about 85% by weight to about 98% by weight of the built-up residue and scum from the developer apparatus.
